(19) United States
(12) Patent Application Publication
(10) Pub. No.: US 2008/0203891 A1
(43) Pub. Date: Aug. 28, 2008

(54) Dielectric Barrier Discharge Lamp With Protective Coating

(75) Inventors: Georg Friedrich Gaertner, Aachen (DE); Georg Greuel, Roetgen (DE); Thomas Juestel, Witten (DE); Joerg Meyer, Aachen (DE); Wolfgang Schiene, Wuerselen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,887

(22) PCT Filed: Jan. 2, 2006
(86) PCT No.: PCT/IB2006/050002

§ 371 Date: Jun. 27, 2007

(30) Foreign Application Priority Data
Jan. 7, 2005 (EP) 05100074.3

(51) Int. Cl. H01J 61/44; C09K 11/81

(52) U.S. Cl. 313/486; 252/301.4 R

(57) ABSTRACT

The subject of the present invention is a system incorporating a DBD lamp (1), a dielectric barrier discharge (DBD-) lamp (1), and a phosphor coating (2) for use as luminescent coating in a dielectric barrier discharge (DBD-) lamp (1), especially in a mercury-free DBD-lamp, comprising several phosphor grains (3a) together forming a luminescent coating layer (3) for converting a primary discharge radiation into a wanted radiation, whereby the phosphor coating (2) comprises a protective coating layer (4) at least partly surrounding the luminescent coating layer (3) for minimizing degradation of the luminescent coating layer (3) during use in a DBD-lamp (1).

The present invention relates to a phosphor coating for use as luminescent coating in a dielectric barrier discharge (DBD-) lamp, especially in a mercury-free DBD-lamp, and a DBD-lamp as well as a system incorporating a DBD-lamp, comprising several phosphor grains together forming a luminescent coating layer for converting a primary discharge radiation into a wanted radiation and the dielectric barrier discharge (DBD-) lamp for generating and emitting an ultraviolet radiation incorporating such a phosphor coating as luminescent coating.

Such well known dielectric barrier discharge lamps are generally known and are used in a wide area of applications, where light waves of a certain wavelength have to be generated for a variety of purposes. Some applications are for example generating UV radiation with wavelengths of about 180 nm to 380 nm for industrial purposes such as waste water treatment, disinfections of drinking water, dechlorination or production of ultra pure water.

Well known dielectric barrier discharge lamps are used for example in flat lamps for liquid crystal display (LCD) backlighting, as cylindrical lamps for photocopiers, and as co-axial lamps for surface and water treatment purposes.

DBD-lamps could be generally of any form. The lamps known from the prior art are typically of a coaxial form consisting of an outer tube and an inner tube melted together on both sides forming an annular discharge gap and having relatively large diameters in respect to the width of the discharge gap. Other types of lamps are of a dome-shaped form consisting of an outer tube, which is closed on one side, and an inner tube, which is also closed on one side, melted together on the non-closed side forming an annular discharge gap and having relatively large diameters in respect to the width of the discharge gap.

EP 1048620, EP 1154461, and DE 10209191 show coaxial dielectric barrier discharge lamps with a suitable phosphor layer coating for generating VUV- or UVC-light.

EP 1048620B1 describes a DBD lamp, which is suited for fluid disinfection and comprises luminescent layers, in this case phosphor layers, which are deposited onto the inner surfaces of the lamp envelope, in this case made of two quartz tubes, which define a discharge volume or a discharge gap. In this case the discharge gap is filled with xenon gas at a certain pressure, which emits a primary radiation as soon as a gas discharge, especially a dielectric barrier discharge, is initiated inside the discharge gap.

This primary plasma radiation with an emitting maximum of about 172 nm is transformed by the luminescent layer into the desired wavelength range for example of about 180 nm to about 380 nm. According to the specified applications, this range can be reduced to a range of 180 nm-190 nm in case of the production of ultra pure water or to a range of 200 nm-280 nm if used for disinfections of water, air, surfaces and the like. The phosphor layer emits a primary radiation in the UV-C range.

In DE 102 09 191 A1 and EP 1154461 A1 similar constructions or arrangements are shown. All of them have in common, that the luminescent or phosphor layer emits only one radiation, that is a primary radiation.

A luminescent coating for a DBD-lamp is generally realized by a phosphor coating, transferring the excimer radiation generated inside the discharge gap—so called volume radiation—into the phosphor specific emission spectrum, for example VUV-, UVC-, UVA-, visible, or infrared spectrum.

For generating high intensity VUV/UVC in the DBD-lamp high electrical wall loads in the order of 2 W/cm² are applied and hence a high intensity discharge with up to 65% discharge efficiency is generated. The phosphor coating is thus exposed to the discharge with high energy and charge deposition, for example if Xe is used as filling, the Xe ion impact, at the walls leading to phosphor degradation and hence reduced efficiency and lifetime.

JP 11-307060 shows a discharge lamp having a metallic dumet wire enveloped by a translucent glas bulb made of soda glass. This bulb has an outer electrode made of a transparent conductive film such as an ITO film in the whole periphery of the outer surface, and the inner surface of the glass bulb is covered with a protecting film made of MgO for example, and furthermore coated with a phosphor. An inner electrode is installed on the inside of the glass bulb. The inner electrode is formed in such a way that a dielectric layer is formed on the surface of a metal conductor made of Dumet wire for example, the protecting layer is formed thereon, and the phosphor is applied to the protecting layer. Sputtering of the electrode can be reduced even if discharge current is increased to heighten brightness.

This well known arrangement has the drawback that the protective film made of MgO is arranged between phosphor film and glass wall and so functions as protective film for the glass wall or in a further embodiment of this arrangement to protect the Dumet wire. Furthermore the protective film is for use in a low power lamp and cannot be used in a highly efficient DBD-lamp as the present invention suggests, where a protective coating protects the luminescent layer.

U.S. Pat. No. 5,604,396 shows a luminescent material for a mercury discharge lamp comprising a phosphor material including phosphor particles for emitting a luminous flux upon excitation by ultraviolet radiation at 254 nm and a protective layer continuously formed on the phosphor particle with at least one metal oxide selected from the group consisting of MgO, Y₂O₃, La₂O₃, Sm₂O₃, Gd₂O₃, Dy₂O₃, Ho₂O₃, Er₂O₃, Yb₂O₃, Lu₂O₃, CaO, ZrO₂, SrO, BaO, α-Al₂O₃ and BeO. A mercury discharge lamp has a luminescent material on the wall of the light transmissive bulb thereof.

This well known arrangement has the drawback, that the protective coating is only for use in a mercury lamp and not as in the present invention in a mercury-free DBD-lamp, that is in convenient low-pressure gas discharge lamps. Therefore the protective layer has different characteristics, that is the transmission rate of this well known protective layer is around 80% at a radiation wavelength of 254 nm, whereby the absorption rate at a wavelength of about 185 nm is at least 50%. This prevents degradation of the phosphor caused by the V-UV radiation of the mercury emission.

Therefore it is an object of the present invention to provide a luminescent coating, preferably a phosphor coating, having suitable characteristics for use in a mercury-free, highly efficient DBD-lamp for guaranteeing a longer durability of the lamp and/or to minimize degradation of the phosphor used in a DBD-lamp.

Another object of the present invention is to provide a DBD-lamp having said luminescent coating and a system incorporating said DBD-lamp.

This issue is addressed by a phosphor coating for use as luminescent coating in a dielectric barrier discharge (DBD-) lamp, especially in a mercury-free DBD-lamp, comprising several phosphor grains together forming a luminescent coating layer for converting a primary discharge radiation into a wanted radiation, whereby the phosphor coating comprises a protective coating layer at least partly surrounding the phosphor coating for minimizing degradation of the luminescent coating layer during use in a DBD-lamp.

It is a major advantage of the present invention, that by an additional protective coating layer of at least a part of the luminescent coating layer or around the phosphor grains, that by this means lifetime, efficiency and/or degradation of the phosphor can be maximized. By this protective coating layer, especially a dense protective coating layer, a phosphor coating with a high light output and improved stability is realized.

The protective coating layer at least partly surrounds the luminescent coating layer, that is on the side of the luminescent coating layer being nearest to the discharge gap. The protective coating layer can as well envelope the whole luminescent coating layer and than serves additionally as a binding means between luminescent coating layer and glass walls for an improved binding.

The phosphor coating is for use as a luminescent coating layer in a DBD-lamp. A DBD-lamp according to this invention comprises an outer part and an inner part. The outer part comprises the envelope of the inner part, whereby the inner part comprises the means for generating the radiation and the emitting light of the DBD-lamp. The inner part of a DBD-lamp according to this invention is structural arranged from the inside to the outside as follows:

The heart of the DBD-lamp is the discharge gap with the filling. This discharge gap is formed by surrounding walls, whereby at least one of these walls is made of a dielectric material and at least one of the walls is at least partly transparent. These walls may be covered at their inner surfaces with a luminescent coating, especially a luminescent coating (layer) for transferring the radiation generated inside the discharge gap into a radiation with a different, especially higher wavelength, which is then emitted to the surrounding of the DBD-lamp. Usually the wavelength of the radiation before being converted by the luminescent coating or the luminescent coating layer—the primary radiation—is in VUV-range (<180 nm). This primary radiation is then converted into a secondary radiation by the luminescent coating (layer), whereby the wavelength of the secondary radiation is preferably in the range between ≧179 nm and ≦400 nm, preferably in the range between ≧180 nm and ≦380 nm and most preferably in the range between ≧180 nm and ≦280 nm.

At their outer surfaces the walls have two corresponding means for electrical contacting for supplying the energy to generate a gas discharge inside the discharge gap and thus for generating a radiation inside the discharge gap. Electrical contacting means can be any means for transferring electrical energy to the lamp, especially electrodes for example in form of a metallic coating layer or a metallic grid. But nevertheless, other means than electrodes can be used for example if the DBD-lamp is used for fluid or water treatment. In this case the DBD-lamp is at least at one side at least partly surrounded by that water or fluid. The surrounding water or fluid than serves as electrical contacting means, whereby again electrodes can transfer the electricity to the water or fluid.

The material for the dielectric wall(s) is selected from the group of dielectric materials, preferably quartz, glass or ceramic. The material for the dielectric walls have to be arranged such, that the radiation can pass at least a part of the outer and/or the inner wall for applying the radiation to the surroundings of the DBD-lamp. Each wall has an inner and an outer surface. The inner surface of each wall is directed to and facing the discharge gap. The distance between the inner surface and the outer surface of one wall defines the wall thickness, which in some special cases can vary. At the outer surfaces or near the outer surfaces the means for electrical contacting are applied. They supply the energy in form of electricity for generating the gas discharge inside the discharge gap and thus generating the radiation inside the discharge gap. For applying the radiation, the electrode or electrical contacting means at/on at least one of the walls has to be arranged such, that radiation from the inside can pass the corresponding electrode. Thus said electrode preferably is arranged as a grid, especially when that electrode is arranged adjacent on the outer surface of the outer wall or on the outer surface of the inner wall. In that case, in that the electrode is spaced to the outer surface of the outer wall or to the outer surface of the inner wall, for example in the case of water treatment, the electrode can be of any suitable material for providing electricity in the corresponding environment.

Preferably the lamp geometry is selected from the group comprising flat lamp geometry, coaxial lamp geometry, dome lamp geometry, a planar lamp geometry and the like. For industrial purposes coaxial DBD-lamps with relatively large diameters compared to the diameter of the discharge gap or the distance between the inner surfaces of the corresponding inner and outer wall or dome-shaped coaxial lamps are preferably used, to achieve a lamp with a large effective area for fluid and surface treatment.

It was found, that the optimal operating (peak) amplitude of a DBD lamp, especially a highly efficient and high power DBD lamp is quite close to—sometimes even just under—the required initial ignition voltage. Therefore, additional means, like auxiliary electrodes or temporary voltage overshoot, are normally necessary to achieve a reliable lamp start-up. All these measures will lead to a more complex and thus more expensive lamp power supply or lamp driver.

Preferably the phosphor coating is mainly made of a material selected from the group of luminescent phosphor comprising: LaPO₄:Pr, YPO₄:Pr, LuPO₄:Pr, YPO₄:Bi, CaSO₄:Pb, MgSO₄:Pb, LuBO₃:Pr, YBO₃:Pr, LiYF₄:Nd, LuPO₄:Nd, and/or YPO₄:Nd Ca₁₋ₓMgₓ)SO₄:Pb, (Y_{1-x-y}LuₓLa_{y})PO₄:Pr, (Y_{1-x-y}LuₓLa_{y})PO₄:Nd, (Y_{1-x-y}LuₓLa_{y})PO₄:Bi, (Y_{1-x-y}LuₓLa_{y})BO₃:Pr, whereby 1-x-y is ≧0, and x and y is in the range ≧0 and ≦1, respectively.

This new material(s) are suitable for high efficiency and do have good luminescent characteristics. This material cooperates well with a protective coating layer so that both materials, that of the luminescent phosphor and that of the protective coating layer are resulting in a phosphor coating resistant against degradation and having high luminescent efficiency. Furthermore this material has good binding characteristics with certain materials serving as material for a protective coating layer, so that the protective coating layer and the luminescent coating layer are strongly coupled.

A phosphor coating or a luminescent coating layer for example comprising YPO₄:Bi has an average grain size being in the range of ≧2 to ≦6 μm and every grain being covered as a whole by a thin, closed MgO-coating. Due to the fact, that amorphous MgO at a wavelength being less than 220 nm starts to absorb radiation and thus starts to absorb the Xe-plasma emitted light—being in the range of 172 nm at raised Xe-partial pressure—the thickness of the coating is one relevant aspect for the efficiency of light emission of the coated phosphor. By means of a suitable procedure for the precipitation of Mg(OH)₂ followed by a step of calcinations for a complete dehydration of said Mg(OH)2 resulting in MgO, as described in the following, dense and very thin coatings having a thickness being in the range of ≧5 and ≦20 nm are realized. The relative low solubility product of Mg(OH)₂—k_{L} about 1,2×10⁻¹¹—and the relative low tendency for hydrolysis result in a stabilisation of phosphor materials that are sensitive to aqueous solutions. This is relevant and advantageously due to the fact that for production of coated DBD-lamps more and more water based phosphor suspensions are used for environment reasons.

The procedure as mentioned before is described in the following:

1.0 g Mg(NO₃)_{2.6}H₂O (3.9 mmol) are solved in 50 ml of water. 8.0 g YPO₄:Bi are suspended and a magnesium-nitrate solution is added. The resulting suspension having a pH-value of about 7.5 is stirred. The suspension is connected to an ammonia solution so that the pH-value after approximately 2 hours is raised around 9.1. Reaching this value the precipitation of Mg(OH)₂ starts. Next stirring is to do, so that the pH-value further raises to about 9.5. Finally the Phosphor is filtered, dried at about 80° C. and calcinated for 2 hours at 450° C.

As a variety the phosphor coating—YPO₄:Bi—layer is enveloped by a layer comprising ultra fine MgO particles gained by a MgO suspension, dried and heated to about 500° C.

Another advantage is that the luminescent phosphor of the luminescent coating layer is suitable for or mainly is made of a material converting a primary discharge radiation into a radiation being in the range of ≧170 nm to ≦300 nm, preferably in the range of ≧180 nm to ≦290 nm, more preferably in the range of ≧183 nm to ≦285 nm, and most preferably in the range of ≧185 nm to ≦280 nm. So the phosphor coating is suitable for mainly all applications where DBD-lamps can be used.

Yet preferably, the protective coating layer is mainly made of a material or comprises a material selected from the group of protective phosphor coating layers comprising: MgO, Al₂O₃, MgAl₂O₄, SiO₄, Y₂SiO₅, La₂SiO₅ Gd₂SiO₅ Lu₂SiO₅ YPO₄, LaPO₄ GdPO₄ LuPO₄ CaSO₄ SrSO₄ and/or BaSO₄. These materials cooperate, as stated before, with the material of the phosphor of the luminescent coating layer, so that a long durable high efficient phosphor coating can be realized. The aforementioned materials do have good binding characteristics for binding the phosphor coating layer to walls for example walls of the DBD-lamp.

To realize an optimized protection, the protective coating layer completely envelopes the luminescent coating layer for protecting the whole luminescent coating layer. Thereby the protective coating layer serves on the one hand as protection against degradation caused from direction of the discharge gap, and on the other hand serves as binding means for a better coupling of phosphor of the luminescent coating layer and the walls.

To realize an optimized protection and to envelope at least a main part of the phosphor of the luminescent coating layer, the protective coating layer completely envelopes at least ≧50% to ≦100%, preferably ≧60% to ≦100%, more preferably ≧75% to ≦100% and most preferably ≧95% to ≦100% of the phosphor grains of the luminescent coating layer for protecting the whole luminescent coating layer.

Optimized protection is realized by completely enveloping the luminescent coating layer. This can be realized by enveloping the luminescent coating layer as a whole, or by enveloping every single part the luminescent coating layer is made of, that is the grains of the luminescent coating layer. By covering every single grain or at least nearly every single grain an enveloping of the luminescent coating layer is realized.

Preferably every grain, that is 100% of the grains is completely enveloped by said protective coating layer. By this the whole luminescent coating layer is enveloped. This grain-enveloping has further the advantage, that due to the good binding characteristics of the protective coating layer, the grains form a more stable and durable luminescent coating layer.

Preferably this luminescent coating layer forming said phosphor coating is used in a DBD-lamp.

Preferably the DBD-lamp for generating and emitting ultraviolet radiation comprises: a housed discharge gap, whereby the housing has at least two walls, whereby at least one of the walls is a dielectric wall and at least one of the walls has an at least partly transparent part, a filling located inside the discharge gap, at least two electrical contacting means for electrical contacting associated with at least the two walls, respectively, and at least one luminescent coating for converting the primary filling discharge radiation to a wanted radiation, whereby the luminescent coating is selected from the group DBD-phosphor coatings comprising said phosphor coating according to the present invention for minimizing degradation of the luminescent coating.

DBD-lamps according to the state of the art do not yet have any protective coatings. In mercury lamps protective coatings has been used, to prevent reaction between the mercury and the material of the luminescent material. In mercury-free DBD-lamps this problem did not arise. Surprisingly it has been found, that special coatings according to the invention do protect the damage of the luminescent layer of DBD-lamps due to short waved radiation, especially in the range ≧160 nm, and due to sputtering of the discharge gas, for example Xe.

To realize a suitable protective coating, a material for the luminescent layer had to be found, which cooperates with the material for the protective coating layer, whereby the lighting characteristics of the DBD-lamp should not be effected negatively. Therefore new materials for the phosphor coating as well as the protective coating layer had to be found, cooperating with the protective coating layer like that materials mentioned before.

Therefore the DBD-lamp preferably comprises such a new phosphor coating.

The aforementioned materials are generally for use in any DBD-lamp. Preferably the filling of the DBD-lamp is mercury free due to environment protection.

Preferably the luminescent coating has a transmission rate in the range of at least ≧50% to ≦100%, preferably from ≧60% to ≦100%, more preferably from ≧70% to ≦100%, and most preferably from ≧75% to ≦100%, and/or the absorption rate at the primary radiation wavelength is in the range of ≧0% to ≦20%, preferably in the range of ≧0% to ≦17%, more preferably in the range of ≧0% to ≦15%, and most preferably in the range of ≧0% to ≦10%.

DBD-lamps with high efficient light output do have luminescent coatings having at least a transmission rate ≧50%, more preferably ≧70%. This guarantees a high light output.

On the other hand the absorption, especially absorption at wavelengths around 172 nm has to be as low as possible, preferably ≦20%, more preferably ≦15%, and most preferably around 10%.

To realize such a DBD-lamp having said characteristics the luminescent coating has a thickness preferably being in the range ≦200 nm, more preferably ≦150 nm, and most preferably ≦100 nm.

Additionally the DBD-lamp or rather the luminescent coating has a high secondary electron emission coefficient preferably being in the range ≧0.001, more preferably ≧0.005, and most preferably ≧0.01.

These characteristics enable the use of a material having a relative large band gap, which makes manufacturing of said luminescent coating more easier and less complex. The materials of said new phosphor coating have these characteristics.

DBD-lamps can be applied in a large variety of applications. Therefore a system is provided incorporating a DBD lamp according to the present invention having a phosphor coating according to the present invention as a luminescent layer and being used in one or more of the following applications: fluid and/or surface treatment of hard and/or soft surfaces, preferably cleaning, disinfection and/or purification; liquid disinfection and/or purification, food and/or beverage treatment and/or disinfection, water treatment and/or disinfection, wastewater treatment and/or disinfection, drinking water treatment and/or disinfection, tap water treatment and/or disinfection, production of ultra pure water, reduction of the total organic carbon content of a liquid or a gas, gas treatment and/or disinfection, air treatment and/or disinfection, exhaust gases treatment and/or cleaning, cracking and/or removing of components, preferably inorganic and/or organic compounds, cleaning of semiconductor surfaces, cracking and/or removing of components from semiconductor surfaces, cleaning and/or disinfection of food supplements, cleaning and/or disinfection of pharmaceuticals.

These and other aspects of the invention will be apparent form and elucidated with reference to the embodiments described hereinafter.

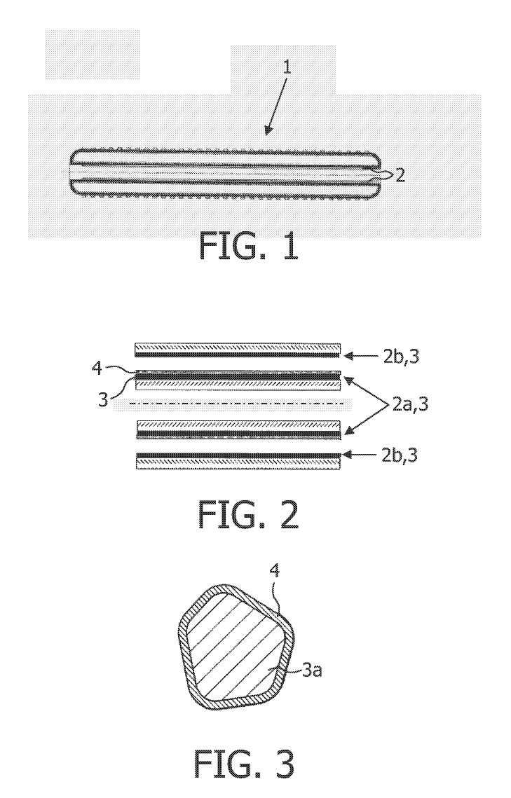

FIG. 1 shows schematically in a longitudinal sectional view a DBD-lamp with a luminescent coating at the inner surface of the walls.

FIG. 2 shows schematically in detail and in a longitudinal sectional view the layer structure of a coaxial DBD-lamp with a discharge gap formed by an inner and an outer quartz tube with a luminescent layer on the inside of the tubes and a protective coating layer.

FIG. 3 shows schematically in an enlarged cross sectional view a phosphor grain enveloped by a protective coating layer.

FIG. 1 shows schematically a coaxial DBD-lamp 1 with an annular shaped discharge gap in a longitudinal sectional view. The discharge gap of the DBD-lamp 1 is formed by a dielectric inner wall and a dielectric outer wall. In this fig. the discharge gap is formed by an inner lamp tube having a circumferential wall, functioning as the inner wall and an outer lamp tube having a circumferential wall, functioning as the outer wall. The lamp tubes are made of quartz glass, which is a dielectric material. The inner wall has an inner surface and an outer surface. The inner surface faces the discharge gap and the outer surface is directed in opposite direction. The thickness of the inner wall is defined by the shortest distance between the inner and the outer surface. The outer wall has an inner surface and an outer surface analogue. The inner surface corresponds to the inner surface of the inner wall and faces the discharge gap. The outer surface is directed in opposite direction to the inner surface. The thickness of the outer wall is defined by the shortest distance between inner surface and outer surface. The DBD-lamp 1 has two corresponding electrodes arranged at the outer and the inner wall. The first electrode is arranged at the outer surface of the inner wall and the second electrode, shaped as a grid, is arranged at the outer surface of the outer wall. At the inner surface of the inner wall a luminescent coating comprising a phosphor coating 2 is arranged and/or located. Also the inner surface of the inner wall has such a luminescent coating comprising a phosphor coating 2. The phosphor coating 2 comprises a luminescent coating layer and a protective coating layer, whereby the luminescent coating layer comprises several single phosphor grains. The diameter of the grains, forming that luminescent coating layer is chosen such, that an optimal reflection of the wavelength-range of the generated UV-radiation is realised.

The filling of the DBD-lamp 1 is a Xe-filling with filling pressures in between 100 mbar and 800 mbar. In this case the wavelength range of the xenon-radiation is about λ=172 nm. This reflected wavelength-range reaches the luminescent coating.

The material for that luminescent coating or rather the phosphor coating 2 or even more precisely the luminescent coating layer or the phosphor grains, is mainly chosen from a material selected from the group of luminescent phosphors comprising: LaPO₄:Pr, YPO₄:Pr, LuPO₄:Pr, YPO₄:Bi, CaSO₄:Pb, MgSO₄:Pb, LuBO₃:Pr, YBO₃:Pr, LiYF₄:Nd, LuPO₄:Nd, and/or YPO₄:Nd Ca₁₋ₓMgₓ)SO₄:Pb, (Y_{1-x-y}LuₓLa_{y})PO₄:Pr, (Y_{1-x-y}LuₓLa_{y})PO₄:Nd, (Y_{1-x-y}LuₓLa_{y})PO₄:Bi, (Y_{1-x-y}LuₓLa_{y})BO₃:Pr, whereby 1-x-y is ≧0, and x and y is in the range ≧0 and ≦1, respectively.

Furthermore the phosphor coating comprises a protective coating layer that is mainly made of a material selected from the group of protective phosphor coating layers comprising: MgO, Al₂O₃, MgAl₂O₄, SiO₄, Y₂SiO₅, La₂SiO₅ Gd₂SiO₅ Lu₂SiO₅ YPO₄, LaPO₄ GdPO₄ LuPO₄ CaSO₄ SrSO₄ and/or BaSO₄.

In this special embodiment the material for the phosphor grains comprises YPO₄:Bi having an average grain size being in the range of ≧2 μm to ≦6 μm and every grain being covered as a whole by a thin, closed MgO-coating. Due to the fact, that amorphous MgO at a wavelength being less than 220 nm starts to absorb radiation and thus starts to absorb the Xe-plasma emitted light—being in the range of 172 nm at raised Xe-partial pressure—the thickness of the protective coating layer of the grains is one relevant aspect for the efficiency of light emission of the phosphor coating. By means of a suitable procedure for the precipitation of Mg(OH)₂ followed by a step of calcinations for a complete dehydration of said Mg(OH)₂ resulting in MgO, as described in the following, dense and very thin coatings having a thickness being in the range of ≧5 and ≦20 nm are realized. The relative low solubility product of Mg(OH)₂—k_{L} about 1,2×10⁻¹¹—and the relative low tendency for hydrolysis result in a stabilisation of phosphor materials that are sensitive to aqueous solutions. This is relevant and advantageously due to the fact that for production of coated DBD-lamps 1 more and more water based phosphor suspensions are used for environment reasons.

The procedure as mentioned before is described in the following:

1.0 g Mg(NO₃)_{2.6}H₂O (3.9 mmol) are solved in 50 ml of water. 8.0 g YPO₄:Bi are suspended and a magnesium-nitrate solution is added. The resulting suspension having a pH-value of about 7.5 is stirred. The suspension is connected to an ammonia solution so that the pH-value after approximately 2 hours is raised around 9.1. Reaching this value the precipitation of Mg(OH)₂ starts. Next stirring is to do, so that the pH-value further raises to about 9.5. Finally the Phosphor is filtered, dried at about 80° C. and calcinated for 2 hours at 450° C.

As a variety the phosphor coating—YPO₄:Bi—layer is enveloped by a layer comprising ultra fine MgO particles gained by a MgO Suspension, dried and heated to about 500° C.

In FIG. 2 schematically the structure of such a phosphor coating 2 having a luminescent coating layer 3 and a protective coating layer 4 covering the luminescent coating layer 3 as a whole is shown. In this fig. two different phosphor coatings are shown, a first phosphor coating 2a at the inner wall and a second phosphor coating 2b at the outer wall of the DBD-lamp. The luminescent coating layer 3 of the second phosphor coating 2b at the outer wall is shown as a luminescent coating layer 3 with each single phosphor grain of the luminescent coating layer 3 being enveloped by a protective coating layer 4.

FIG. 2 shows in detail and in a longitudinal sectional view the layer structure of a coaxial DBD-lamp with a discharge gap formed by an inner and an outer quartz tube according to the layer structure according to FIG. 1 with a first phosphor coating 2a on the inside of the inner tube comprising a luminescent coating layer 3 comprising several phosphor grains and a protective coating layer 4 adjacent located between the discharge gap and the luminescent coating layer 3. The DBD-lamp or rather the walls of the DBD-lamp are rotation-symmetrical constructed. The dotted-line represents the rotational axis. The layer structure is described from the inside that is from the rotational axis to the outside. The inner layer is the inner wall. Arranged at the inner wall is the first phosphor coating 2a comprising a luminescent coating layer 3 which is mainly build of several single phosphor grains. The luminescent coating layer 3 is covered by a protective coating layer 4. Both forming the first phosphor coating 2a.

The discharge gap further contains a filling here Xe. The second phosphor coating layer 2b comprising a luminescent coating layer 3 mainly built of several single phosphor grains and a protective coating layer 4, whereby the protective coating layer 4 envelopes every single phosphor grain, is located at the outer wall. The first phosphor coating 2a comprises a luminescent coating layer 3 which is covered as a whole by a protective coating layer 4, the second phosphor coating 2b comprises a luminescent coating layer 3 mainly consisting of several single phosphor grains, each enveloped by a protective coating layer 4. The latter structure is schematically shown in FIG. 3.

FIG. 3 shows schematically in an enlarged cross sectional view a single phosphor grain 3a enveloped by a protective coating layer 4. The protective coating layer 4 completely envelopes or surrounds the phosphor grain 3a. All enveloped phosphor grains 3a together form the second phosphor coating 2b.

### LIST OF REFERENCE NUMBERS

1 dielectric barrier discharge lamp (DBD lamp)
2 phosphor coating
2a first phosphor coating
2b second phosphor coating
3 luminescent coating layer
3a phosphor grain
4 protective coating layer

1. Phosphor coating (2) for use as luminescent coating in a dielectric barrier discharge (DBD-) lamp (1), especially in a mercury-free DBD-lamp, comprising several phosphor grains (3a) together forming a luminescent coating layer (3) for converting a primary discharge radiation into a wanted radiation, whereby the phosphor coating (2) further comprises a protective coating layer (4) at least partly surrounding the luminescent coating layer (3) for minimizing degradation of the luminescent coating layer (3) during use in a DBD-lamp (1).

2. Phosphor coating (2) according to claim 1, whereby the luminescent coating layer (3) comprises a material selected from the group of luminescent phosphors comprising: LaPO₄:Pr, YPO₄:Pr, LuPO₄:Pr, YPO₄:Bi, CaSO₄:Pb, MgSO₄:Pb, LuBO₃:Pr, YBO₃:Pr, LiYF₄:Nd, LuPO₄:Nd, YPO₄ :Nd Ca₁₋ₓMgₓ)SO₄ :Pb, (Y_{1-x-y}LuₓLa_{y})PO₄:Pr, (Y_{1-x-y}LuₓLa_{y})PO₄:Nd, (Y_{1-x-y}LuₓLa_{y})PO₄:Bi, and/or (Y_{1-x-y}LuₓLa_{y})BO₃:Pr, whereby 1-x-y is ≧0, and x and y is in the range ≧0 and ≦1, respectively.

3. Phosphor coating (2) according to claim 1, whereby the luminescent phosphor of the luminescent coating layer (3) is suitable to convert a primary discharge radiation into a radiation being in the range of ≧170 nm to ≦300 nm, preferably in the range of ≧180 nm to ≦290 nm, more preferably in the range of ≧183 nm to ≦285 nm, and most preferably in the range of ≧185 nm to ≦280 nm.

4. Phosphor coating (2) according to claim 1, whereby the protective coating layer (4) comprises a material selected from the group of protective phosphor coating layers comprising: MgO, Al₂O₃, MgAl₂O₄, SiO₄, Y₂SiO₅, La₂SiO₅ Gd₂SiO₅ Lu₂SiO₅ YPO₄, LaPO₄ GdPO₄ LuPO₄ CaSO₄ SrSO₄ and/or BaSO₄.

5. Phosphor coating (2) according to claim 1, whereby the protective coating layer (4) completely envelops the luminescent coating layer (3) for protecting the whole luminescent coating layer (3).

6. Phosphor coating (2) according to claim 1, whereby the protective coating layer (4) completely envelops at least ≧50% to ≦100%, preferably ≧60% to ≦100%, more preferably ≧75% to ≦100% and most preferably ≧95% to ≦100% of the phosphor grains (3a) of the luminescent coating layer (3) for protecting the whole luminescent coating layer (3).

7. Dielectric barrier discharge (DBD-) lamp (1) for generating and emitting ultraviolet radiation comprising:
a housed discharge gap, whereby the housing has at least two walls, whereby at least one of the walls is a dielectric wall and at least one of the walls has an at least partly transparent part,
a filling located inside the discharge gap,
at least two electrical contacting means for electrical contacting associated with at least the two walls, respectively, and
at least one luminescent coating for converting the primary filling discharge radiation to a wanted radiation, whereby the luminescent coating is selected from the group of DBD-phosphor coatings comprising said phosphor coating (1) according to claim 1 for minimizing degradation of the luminescent coating.

8. DBD lamp (1) according to claim 7, whereby the filling of the DBD-lamp (1) is mercury free for an environment friendly DBD-lamp (1).

9. DBD lamp (1) according to claim 7, whereby the luminescent coating has a transmission rate in the range of at least ≧50% to ≦100%, preferably from ≧60% to ≦100%, more preferably from ≧70% to ≦100%, and most preferably from ≧75% to ≦100%, and/or the absorption rate at the primary radiation wavelength is in the range of ≧0% to ≦20%, preferably in the range of ≧0% to ≦17%, more preferably in the range of ≧0% to ≦15%, and most preferably in the range of ≧0% to ≦10%.

10. A system incorporating a DBD lamp (1) according to claim 7 having a phosphor coating (2) for use as luminescent coating in a dielectric barrier discharge (DBD-) lamp (1), especially in a mercury-free DBD-lamp, comprising several phosphor grains (3a) together forming a luminescent coating layer (3) for converting a primary discharge radiation into a wanted radiation, whereby the phosphor coating (2) further comprises a protective coating layer (4) at least partly surrounding the luminescent coating layer (3) for minimizing degradation of the luminescent coating layer (3) during use in a DBD-lamp (1) as a luminescent layer and being used in one or more of the following applications:
fluid and/or surface treatment of hard and/or soft surfaces, preferably cleaning, disinfection and/or purification;
liquid disinfection and/or purification,
food and/or beverage treatment and/or disinfection,
water treatment and/or disinfection,
wastewater treatment and/or disinfection,
drinking water treatment and/or disinfection,
tap water treatment and/or disinfection,
production of ultra pure water,
reduction of the total organic carbon content of a liquid or a gas,
gas treatment and/or disinfection,
air treatment and/or disinfection,
exhaust gases treatment and/or cleaning,
cracking and/or removing of components, preferably inorganic and/or organic compounds,
cleaning of semiconductor surfaces,
cracking and/or removing of components from semiconductor surfaces,
cleaning and/or disinfection of food supplements,
cleaning and/or disinfection of pharmaceuticals.
